(19) United States
(12) Patent Application Publication
(10) Pub. No.: US 2025/0392197 A1
(43) Pub. Date: Dec. 25, 2025

(54) CONTROLLER FOR INJECTION MOLDING MACHINE, AND INJECTION MOLDING MACHINE

(71) Applicant: SUMITOMO HEAVY INDUSTRIES, LTD., Tokyo (JP)

(72) Inventor: Kota KANEUMI, Chiba (JP)

(21) Appl. No.: 19/237,428

(22) Filed: Jun. 13, 2025

(30) Foreign Application Priority Data
Jun. 21, 2024 (JP) 2024-100441

(51) Int. Cl. H02K 11/33; B29C 45/17; H02K 7/10

(52) U.S. Cl. CPC H02K 11/33; H02K 7/10; B29C 2045/1792; B29C 2945/76792

(57) ABSTRACT

A controller for an injection molding machine includes a digital circuit configured to, in response to receiving a signal indicating detection of an occurrence of a predetermined event from a detector provided in the injection molding machine including a motor configured to supply power for moving a movable part and including a brake for the motor, control an output of a first signal for performing power interruption for interrupting power supply to the motor and an output of a second signal for starting braking by the brake, such that control of the output of the second signal is performed after control of the output of the first signal.

### CROSS-REFERENCE TO RELATED APPLICATIONS

This application is based upon and claims priority to Japanese Patent Application No. 2024-100441, filed on Jun. 21, 2024, the entire contents of which are incorporated herein by reference.

### BACKGROUND

### 1. Technical Field

The present disclosure relates to a controller for an injection molding machine, and an injection molding machine.

### 2. Description of Related Art

Various controls have been performed to ensure safety when operating injection molding machines. For example, related art discloses an injection molding machine including a safety door, a detector configured to detect the opening/closing state of the safety door, and a control part configured to stop a driver based on a detection result obtained by the detector. The control part of this injection molding machine stops a motor driver by stopping excitation of a coil of a relay switch, configured to drive a motor driver of a clamping mechanism, in response to switching of a switch in accordance with opening of the safety door.

In existing injection molding machines, for stopping a movable part, power interruption of an actuator configured to operate the movable part, and braking control by a brake configured to stop the actuator are typically performed. In these injection molding machines, the power interruption and the braking control are performed by different devices. Because different devices perform the power interruption and the braking control, it has been challenging to perform the power interruption and the braking control in this order with high accuracy when stopping the movable part.

### SUMMARY

A controller for an injection molding machine according to an aspect of the present disclosure includes a digital circuit configured to, in response to receiving a signal indicating detection of an occurrence of a predetermined event from a detector provided in the injection molding machine including a motor configured to supply a power for moving a movable part and including a brake for the motor, control an output of a first signal for performing power interruption for interrupting power supply to the motor and an output of a second signal for starting braking by the brake, such that control of the output of the second signal is performed after control of the output of the first signal.

### BRIEF DESCRIPTION OF THE DRAWINGS

FIG. 1 is a diagram illustrating the state of an injection molding machine according to an embodiment at the completion of mold opening;

FIG. 2 is a view illustrating the state of the injection molding machine according to the embodiment during mold clamping;

FIG. 3 is a diagram illustrating an example of an electrical configuration of a programmable logic controller (PLC) according to one embodiment;

FIG. 4 is a functional configuration diagram illustrating a main configuration of a controller and the PLC according to the one embodiment;

FIG. 5 is a timing chart of power interruption and braking control by a brake performed when a safety door is opened in an injection molding machine according to the one embodiment; and

FIG. 6 is a diagram illustrating an example of an electrical configuration of a PLC according to another embodiment.

### DETAILED DESCRIPTION

An aspect of the present disclosure provides a technology of improving certainty in performing power interruption and braking control in this order, thereby realizing an improvement in safety.

Hereinafter, embodiments of the present disclosure will be described with reference to the drawings. The below-described embodiments should not be construed to limit the present disclosure, i.e., they are merely examples. The features described in the embodiments or combinations of the features are not necessarily essential to the present disclosure. In the drawings, the same or corresponding configurations are referred to using the same or corresponding symbols, and description thereof may be omitted.

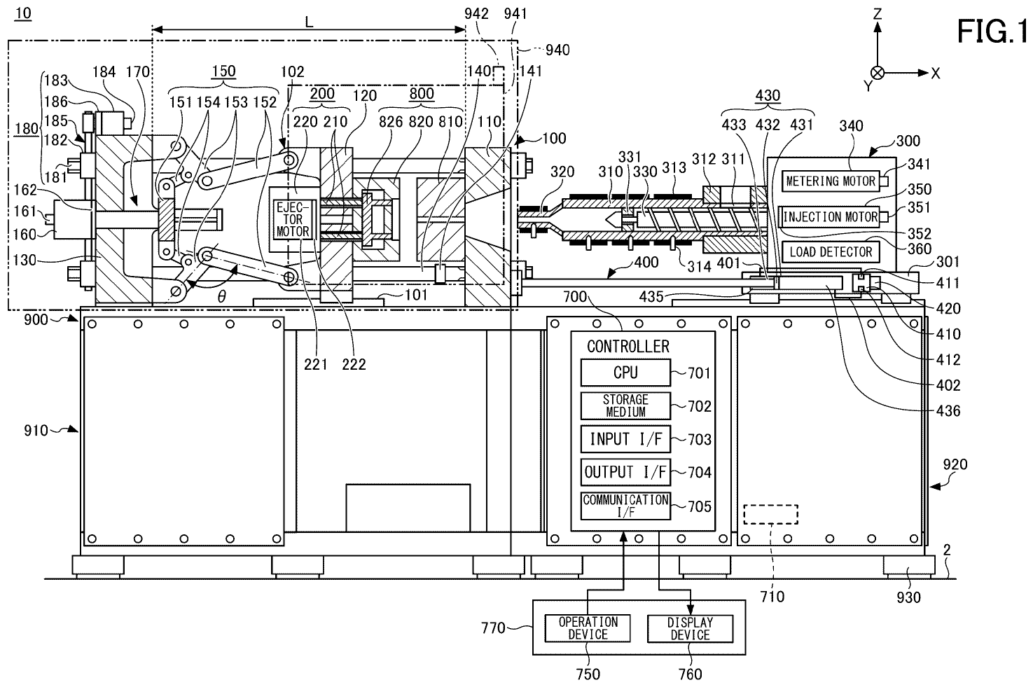

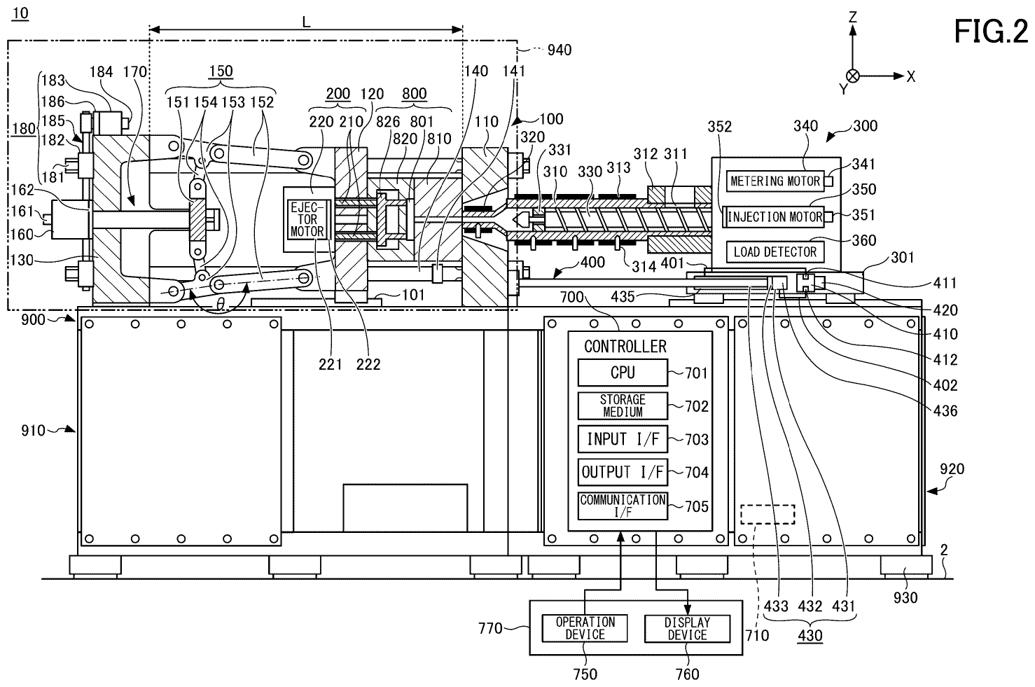

FIG. 1 is a diagram illustrating the state of an injection molding machine according to one embodiment at the completion of mold opening. FIG. 2 is a diagram illustrating the state of the injection molding machine according to the one embodiment during mold clamping. In this specification, the X-axis direction, the Y-axis direction, and the Z-axis direction are perpendicular to each other. The X-axis direction and the Y-axis direction represent horizontal directions, and the Z-axis direction represents a vertical direction. When a mold clamping part 100 is of a horizontal type, the X-axis direction is a mold opening/closing direction, and the Y-axis direction is a widthwise direction of an injection molding machine 10. The negative side in the Y-axis direction is referred to as “operation side”, and the positive side in the Y-axis direction is referred to as “non-operation side.”

As illustrated in FIG. 1 and FIG. 2, the injection molding machine 10 includes the mold clamping part 100 that opens and closes a mold part 800, an ejector 200 that ejects a molded product in the mold part 800, an injection part 300 that injects a molding material into the mold part 800, a movement part 400 that moves the injection part 300 toward and away from the mold part 800, a controller 700 that controls the components of the injection molding machine 10, and a frame 900 that supports the components of the injection molding machine 10. The frame 900 includes a mold clamping part frame 910 that supports the mold clamping part 100 and an injection part frame 920 that supports the injection part 300. Each of the mold clamping part frame 910 and the injection part frame 920 is installed on a floor 2 via at least one leveling adjuster 930. The controller 700 is placed in the internal space of the injection part frame 920. Each component of the injection molding machine 10 is described below.

### (Mold Clamping Part)

In the description of the mold clamping part 100, the direction of movement of a movable platen 120 during mold closing (e.g., the positive X-axis direction) is referred to as “forward direction”, and the direction of movement of the movable platen 120 during mold opening (e.g., the negative X-axis direction) is referred to as “backward direction.”

The mold clamping part 100 closes, pressurizes, clamps, depressurizes, and opens the mold part 800. The mold part 800 includes a stationary mold 810 and a movable mold 820. The mold clamping part 100 is, for example, of a horizontal type, and the mold opening and closing directions are horizontal directions. The mold clamping part 100 includes a stationary platen 110 to which the stationary mold 810 is attached, the movable platen 120 to which the movable mold 820 is attached, and a movement mechanism 102 that moves the movable platen 120 in the mold opening and closing directions relative to the stationary platen 110.

The stationary platen 110 is fixed to the mold clamping part frame 910. The stationary mold 810 is attached to a surface of the stationary platen 110 that faces the movable platen 120.

The movable platen 120 is placed to be movable in the mold opening and closing directions relative to the mold clamping part frame 910. A guide 101 that guides the movable platen 120 is laid on the mold clamping part frame 910. The movable mold 820 is attached to a surface of the movable platen 120 that faces the stationary platen 110.

The movement mechanism 102 moves the movable platen 120 toward and away from the stationary platen 110 to close, pressurize, clamp, depressurize, and open the mold part 800. The movement mechanism 102 includes a toggle support 130 spaced apart from the stationary platen 110, a tie bar 140 connecting the stationary platen 110 and the toggle support 130, a toggle mechanism 150 that moves the movable platen 120 in the mold opening and closing directions relative to the toggle support 130, a mold clamping motor 160 that actuates the toggle mechanism 150, a motion conversion mechanism 170 that converts the rotational motion of the mold clamping motor 160 into linear motion, and a mold thickness adjustment mechanism 180 that adjusts the interval between the stationary platen 110 and the toggle support 130.

The toggle support 130 is spaced apart from the stationary platen 110 and is placed on the mold clamping part frame 910 to be movable in the mold opening and closing directions. The toggle support 130 may be placed to be movable along a guide laid on the mold clamping part frame 910. The guide 101 of the movable platen 120 may also serve as the guide of the toggle support 130.

According to the present embodiment, the stationary platen 110 is fixed to the mold clamping part frame 910 and the toggle support 130 is placed to be movable in the mold opening and closing directions relative to the mold clamping part frame 910. However, the toggle support 130 may be fixed to the mold clamping part frame 910 and the stationary platen 110 may be placed to be movable in the mold opening and closing directions relative to the mold clamping part frame 910.

The tie bar 140 connects the stationary platen 110 and the toggle support 130 with an interval (distance) L therebetween in the mold opening and closing directions. Multiple (e.g., four) tie bars may be used as the tie bar 140. The multiple tie bars 140 are placed parallel to the mold opening and closing directions and extend according to a mold clamping force. At least one tie bar 140 among the multiple tie bars 140 may be provided with a tie bar strain detector 141 that detects the strain of the tie bar 140. The tie bar strain detector 141 transmits a signal indicating the detection result to the controller 700. The detection result of the tie bar strain detector 141 is used to detect the mold clamping force.

According to the present embodiment, the tie bar strain detector 141 is used as a mold clamping force detector to detect a mold clamping force. The present disclosure, however, is not limited to this configuration. The mold clamping force detector is not limited to be of a strain gauge type and may be of a piezoelectric type, a capacitive type, a hydraulic type, an electromagnetic type, or the like, and its attachment position is not limited to the tie bar 140.

The toggle mechanism 150 is placed between the movable platen 120 and the toggle support 130, and moves the movable platen 120 in the mold opening and closing directions relative to the toggle support 130. The toggle mechanism 150 includes a crosshead 151 that moves in the mold opening and closing directions and a pair of link groups that are extended and contracted by the movement of the crosshead 151. Each link group includes a first link 152 and a second link 153 that are extendable and contractible when connected by a pin or the like. The first link 152 is pivotably attached to the movable platen 120 with a pin or the like. The second link 153 is pivotably attached to the toggle support 130 with a pin or the like. The second link 153 is attached to the crosshead 151 via a third link 154. The crosshead 151 is moved toward or away from the toggle support 130 to contract or extend the first link 152 and the second link 153 to move the movable platen 120 toward or away from the toggle support 130.

The configuration of the toggle mechanism 150 is not limited to the configuration illustrated in FIG. 1 and FIG. 2. For example, the number of nodes of each link group, which is five in FIG. 1 and FIG. 2, may be four, and one end of the third link 154 may be connected to the node of the first link 152 and the second link 153.

The mold clamping motor 160 is attached to the toggle support 130 to actuate the toggle mechanism 150. The mold clamping motor 160 moves the crosshead 151 toward or away from the toggle support 130 to contract or extend the first link 152 and the second link 153 to move the movable platen 120 toward or away from the toggle support 130. The mold clamping motor 160, which is directly connected to the motion conversion mechanism 170, may alternatively be connected to the motion conversion mechanism 170 via a belt or pulley.

The mold clamping motor 160 includes a built-in motor brake 162. The motor brake 162 operates to stop rotation of a motor shaft of the mold clamping motor 160. The motor brake 162 is, for example, a non-excitation brake, and operates when power supply is stopped.

The motion conversion mechanism 170 converts the rotational motion of the mold clamping motor 160 into the linear motion of the crosshead 151. The motion conversion mechanism 170 includes a screw shaft and a screw nut screwed to the screw shaft. Balls or rollers may be interposed between the screw shaft and the screw nut.

The mold clamping part 100 performs a mold closing process, a pressurizing process, a mold clamping process, a depressurizing process, a mold opening process, and the like under the control of the controller 700.

In the mold closing process, the mold clamping motor 160 is driven to move the crosshead 151 forward to a mold closing completion position at a set travel speed to move the movable platen 120 forward to cause the movable mold 820 to touch the stationary mold 810. The position and travel speed of the crosshead 151 are detected using a mold clamping motor encoder 161 or the like. The mold clamping motor encoder 161 detects the rotation of the mold clamping motor 160 and transmits a signal indicating the detection results to the controller 700.

A crosshead position detector that detects the position of the crosshead 151 and a crosshead travel speed detector that detects the travel speed of the crosshead 151 are not limited to the mold clamping motor encoder 161 and common ones may be employed. Furthermore, a movable platen position detector that detects the position of the movable platen 120 and a movable platen travel speed detector that detects the travel speed of the movable platen 120 are not limited to the mold clamping motor encoder 161 and common ones may be employed.

In the pressurizing process, the mold clamping motor 160 is further driven to further move the crosshead 151 from the mold closing completion position to a mold clamping position, thereby generating a mold clamping force.

In the mold clamping process, the mold clamping motor 160 is driven to maintain the position of the crosshead 151 at the mold clamping position. In the mold clamping process, the mold clamping force generated in the pressurizing process is maintained. In the mold clamping process, a cavity space 801 (see FIG. 2) is formed between the movable mold 820 and the stationary mold 810, and the injection part 300 fills the cavity space 801 with a liquid molding material. The molding material is solidified, so that a molded product is obtained.

The number of cavity spaces 801 may be one or more. In the latter case, multiple molded products are simultaneously obtained. An insert material may be placed in part of the cavity space 801 and the molding material may fill another part of the cavity space 801. Thereby, a molded product into which the insert material and the molding material are integrated is obtained.

In the depressurizing process, the mold clamping motor 160 is driven to move the crosshead 151 backward from the mold clamping position to a mold opening start position to move the movable platen 120 backward to reduce the mold clamping force. The mold opening start position and the mold closing completion position may be the same position.

In the mold opening process, the mold clamping motor 160 is driven to move the crosshead 151 backward from the mold opening start position to a mold opening completion position at a set travel speed to move the movable platen 120 backward to separate the movable mold 820 from the stationary mold 810. Thereafter, the ejector 200 ejects the molded product from the movable mold 820.

Set conditions in the mold closing process, the pressurizing process, and the mold clamping process are collectively set as a series of set conditions. For example, the travel speed and positions (including a mold closing start position, a travel speed switch position, the mold closing completion position, and the mold clamping position) of the crosshead 151 and the mold clamping force in the mold closing process and the pressurizing process are collectively set as a series of set conditions. The mold closing start position, the travel speed switch position, the mold closing completion position, and the mold clamping position, which are arranged in this order in the forward direction from the back side, represent the start points and end points of sections for which the travel speed is set. The travel speed is set section by section. There may be one or more travel speed switch positions. The travel speed switch position may not be set. Only one of the mold clamping position or the mold clamping force may be set.

Setting conditions in the depressurizing process and the mold opening process are likewise set. For example, the travel speed and positions (the mold opening start position, the travel speed switch position, and the mold opening completion position) of the crosshead 151 in the depressurizing process and the mold opening process are collectively set as a series of set conditions. The mold opening start position, the travel speed switch position, and the mold opening completion position, which are arranged in this order in the backward direction from the front side, represent the start points and end points of sections for which the travel speed is set. The travel speed is set section by section. There may be one or more travel speed switch positions. The travel speed switch position may not be set. The mold opening start position and the mold closing completion position may be the same position. The mold opening completion position and the mold closing start position may be the same position.

Instead of the travel speed, position, and the like, of the crosshead 151, the travel speed, position, and the like, of the movable platen 120 may be set. Furthermore, instead of the crosshead position (e.g., the mold clamping position) or the movable platen position, the mold clamping force may be set.

The toggle mechanism 150 amplifies the driving force of the mold clamping motor 160 and transmits the amplified driving force to the movable platen 120. The amplification factor is also referred to as “toggle multiplying factor.” The toggle multiplying factor changes according to the angle θ formed by the first link 152 and the second link 153 (hereinafter also referred to as “link angle θ”). The link angle θ is determined from the position of the crosshead 151. The toggle multiplying factor is maximized when the link angle θ is 180°.

When there is a change in the thickness of the mold part 800 because of the replacement of the mold part 800 or a change in the temperature of the mold part 800, the mold thickness is adjusted to obtain a predetermined mold clamping force at the time of mold clamping. In adjusting the mold thickness, for example, the interval L between the stationary platen 110 and the toggle support 130 is adjusted so that the link angle θ of the toggle mechanism 150 becomes a predetermined angle at the time of mold touch when the movable mold 820 touches the stationary mold 810.

The mold clamping part 100 includes the mold thickness adjustment mechanism 180. The mold thickness adjustment mechanism 180 adjusts the mold thickness by adjusting the interval L between the stationary platen 110 and the toggle support 130. The mold thickness is adjusted between the end of a molding cycle and the start of the next molding cycle, for example. The mold thickness adjustment mechanism 180 includes, for example, a threaded shaft 181 formed at the rear end of each tie bar 140, a threaded nut 182 held on the toggle support 130 in such a manner as to be rotatable and impossible to move forward or backward, and a mold thickness adjustment motor 183 that rotates the threaded nut 182 mating with the threaded shaft 181.

The threaded shaft 181 and the threaded nut 182 are provided for each tie bar 140. The rotational driving force of the mold thickness adjustment motor 183 may be transmitted to the multiple threaded nuts 182 via a rotational driving force transmission part 185. It is possible to synchronously rotate the multiple threaded nuts 182. The multiple threaded nuts 182 may be individually rotated by changing the transmission channel of the rotational driving force transmission part 185.

The rotational driving force transmission part 185 is constituted of, for example, gears. In such a case, a driven gear is formed at the periphery of each threaded nut 182, a drive gear is attached to the output shaft of the mold thickness adjustment motor 183, and an intermediate gear that meshes with the driven gears and the drive gear is rotatably held in the center of the toggle support 130. The rotational driving force transmission part 185 may be constituted of a belt and pulleys instead of gears.

The operation of the mold thickness adjustment mechanism 180 is controlled by the controller 700. The controller 700 drives the mold thickness adjustment motor 183 to rotate the threaded nuts 182. As a result, the position of the toggle support 130 relative to the tie bars 140 is adjusted, and the interval L between the stationary platen 110 and the toggle support 130 is adjusted. Multiple mold thickness adjustment mechanisms may be used in combination.

The interval L is detected using a mold thickness adjustment motor encoder 184. The mold thickness adjustment motor encoder 184 detects the amount of rotation and the direction of rotation of the mold thickness adjustment motor 183, and transmits a signal indicating the detection results to the controller 700. The detection results of the mold thickness adjustment motor encoder 184 are used to monitor and control the position of the toggle support 130 and the interval L. A toggle support position detector that detects the position of the toggle support 130 and an interval detector that detects the interval L are not limited to the mold thickness adjustment motor encoder 184 and common ones may be employed.

The mold thickness adjustment motor 183 includes a built-in motor brake 186. The mold thickness adjustment motor 183 operates to stop rotation of a motor shaft of the mold thickness adjustment motor 183. The motor brake 186 is, for example, a non-excitation brake, and operates when power supply is stopped.

The mold clamping part 100 may include a mold temperature adjuster that adjusts the temperature of the mold part 800. The mold part 800 contains a flow path for a temperature adjust medium. The mold temperature adjuster adjusts the temperature of the mold part 800 by adjusting the temperature of the temperature adjust medium supplied to the flow path of the mold part 800.

The mold clamping part 100, which is of a horizontal type whose mold opening and closing directions are horizontal directions according to the present embodiment, may also be of a vertical type whose mold opening and closing directions are vertical directions.

The mold clamping part 100, which includes the mold clamping motor 160 as a drive source according to the present embodiment, may also include a hydraulic cylinder instead of the mold clamping motor 160. Furthermore, the mold clamping part 100 may include a linear motor for mold opening and closing and may include an electromagnet for mold clamping.

### (Ejector)

In the description of the ejector 200, similar to the description of the mold clamping part 100, the direction of movement of the movable platen 120 during mold closing (e.g., the positive X-axis direction) is referred to as “forward direction”, and the direction of movement of the movable platen 120 during mold opening (e.g., the negative X-axis direction) is referred to as “backward direction.”

The ejector 200 is attached to the movable platen 120 and moves forward and backward together with the movable platen 120. The ejector 200 includes one or more ejector rods 210 that eject a molded product from the mold part 800 and a drive mechanism 220 that moves the ejector rod 210 in the directions of movement (the X-axis direction) of the movable platen 120.

Each ejector rod 210 is placed in a through hole of the movable platen 120 to be movable forward and backward. The front end of the ejector rod 210 contacts an ejector plate 826 of the movable mold 820. The front end of the ejector rod 210 may be connected to or disconnected from the ejector plate 826.

The drive mechanism 220 includes, for example, an ejector motor 221 and a motion conversion mechanism that converts the rotational motion of the ejector motor 221 into the linear motion of the ejector rod 210. The motion conversion mechanism includes a threaded shaft and a threaded nut that mates with the threaded shaft. Balls or rollers may be interposed between the threaded shaft and the threaded nut.

The ejector 200 executes an ejection process under the control of the controller 700. In the ejection process, the ejector rods 210 are moved forward from a standby position to an ejection position at a set travel speed to move the ejector plate 826 forward to eject a molded product. Thereafter, the ejector motor 221 is driven to move the ejector rods 210 backward at a set travel speed to move the ejector plate 826 backward to the initial standby position.

The position and travel speed of the ejector rods 210 are detected using an ejector motor encoder, for example. The ejector motor 221 encoder detects the rotation of the ejector motor to transmit a signal indicating the detection results to the controller 700. An ejector rod position detector that detects the position of the ejector rods 210 and an ejector rod travel speed detector that detects the travel speed of the ejector rods 210 are not limited to the ejector motor encoder and common ones may be employed.

The ejector motor 221 includes a built-in motor brake 222. The motor brake 222 operates to stop rotation of a motor shaft of the ejector motor 221. The motor brake 222 is, for example, a non-excitation brake, and operates when power supply is stopped.

### (Injection Part)

Unlike in the description of the mold clamping part 100 and the ejector 200, in the description of the injection part 300, the direction of movement of a screw 330 during filling (e.g., the negative X-axis direction) is referred to as “forward direction”, and the direction of movement of the screw 330 during metering (e.g., the positive X-axis direction) is referred to as “backward direction.”

The injection part 300 is installed on a slidable base 301, and the slidable base 301 is so placed as to be movable forward and backward relative to the injection part frame 920. The injection part 300 is so placed as to be movable toward and away from the mold part 800. The injection part 300 touches the mold part 800 to fill the cavity space 801 within the mold part 800 with a molding material metered in a cylinder 310. The injection part 300 includes, for example, the cylinder 310 that heats a molding material, a nozzle 320 provided at the front end of the cylinder 310, the screw 330 so placed in the cylinder 310 as to be movable forward and backward and rotatable, a metering motor 340 that rotates the screw 330, an injection motor 350 that moves the screw 330 forward and backward, and a load detector 360 that detects a load transmitted between the injection motor 350 and the screw 330.

The cylinder 310 heats a molding material supplied to the inside through a supply port 311. Examples of the molding material include resin. The molding material is formed into pellets, for example, and is supplied to the supply port 311 in a solid state. The supply port 311 is formed in a rear portion of the cylinder 310. A cooler 312 such as a water-cooled cylinder is provided on the outer cylindrical surface of the rear portion of the cylinder 310. Heaters 313 such as a band heater and temperature detectors 314 are provided forward of the cooler 312 on the outer cylindrical surface of the cylinder 310.

The cylinder 310 is divided into multiple zones in the axial direction (e.g., the X-axis direction) of the cylinder 310. Each zone is provided with the heater 313 and the temperature detector 314. A temperature is set for each zone and the controller 700 controls the heater 313 so that the temperature detected by the temperature detector 314 becomes the set temperature.

The nozzle 320 is provided at the front end of the cylinder 310 to be pressed against the mold part 800. The heater 313 and the temperature detector 314 are provided at the periphery of the nozzle 320. The controller 700 controls the heater 313 so that the detected temperature of the nozzle 320 becomes the set temperature.

The screw 330 is placed in the cylinder 310 to be rotatable and movable forward and backward. When the screw 330 rotates, a molding material is fed forward along the helical groove of the screw 330. The molding material is gradually melted by heat from the cylinder 310 as the molding material is fed forward. As the molding material in liquid form is fed forward on the screw 330 to be accumulated in the front of the cylinder 310, the screw 330 is moved backward. Thereafter, when the screw 330 is moved forward, the molding material in liquid form accumulated in front of the screw 330 is injected into the mold part 800 through the nozzle 320.

A backflow prevention ring 331 is so attached to a front portion of the screw 330 as to be movable forward and backward as a backflow check valve that prevents the backflow of the molding material from the front to the back of the screw 330 when the screw 330 is pushed forward.

When the screw 330 is moved forward, the backflow prevention ring 331 is pushed backward by the pressure of the molding material in front of the screw 330 to move backward relative to the screw 330 to a closing position (see FIG. 2) that closes the flow channel of the molding material, thereby preventing the backflow of the molding material accumulated in front of the screw 330 in the backward direction.

When the screw 330 is rotated, the backflow prevention ring 331 is pushed forward by the pressure of the molding material fed forward along the helical groove of the screw 330 to move forward relative to the screw 330 to an open position (see FIG. 1) that opens the flow channel of the molding material. As a result, the molding material is fed forward of the screw 330.

The backflow prevention ring 331 may be of a co-rotating type that rotates together with the screw 330 or of a non-co-rotating type that does not rotate together with the screw 330.

The injection part 300 may include a drive source that moves the backflow prevention ring 331 forward and backward between the open position and the closing position relative to the screw 330.

The metering motor 340 rotates the screw 330. The drive source that rotates the screw 330 is not limited to the metering motor 340 and may be, for example, a hydraulic pump.

The injection motor 350 moves the screw 330 forward and backward. A motion conversion mechanism that converts the rotational motion of the injection motor 350 into the linear motion of the screw 330, and the like, are provided between the injection motor 350 and the screw 330. The motion conversion mechanism includes, for example, a threaded shaft and a threaded nut that mates with the threaded shaft. Balls or rollers may be provided between the threaded shaft and the threaded nut. The drive source that moves the screw 330 forward and backward is not limited to the injection motor 350, and may be, for example, a hydraulic cylinder.

The injection motor 350 includes a built-in motor brake 352. The motor brake 352 operates to stop rotation of a motor shaft of the injection motor 350. The motor brake 352 is, for example, a non-excitation brake, and operates when power (signal) supply is stopped.

The load detector 360 detects a load transmitted between the injection motor 350 and the screw 330. The detected load is converted into pressure in the controller 700. The load detector 360 is provided in the load transmission path between the injection motor 350 and the screw 330 to detect a load applied to the load detector 360.

The load detector 360 transmits a signal of the detected load to the controller 700. The load detected by the load detector 360 is converted into a pressure applied between the screw 330 and the molding material, and is used to control and monitor a pressure that the screw 330 receives from the molding material, a back pressure against the screw 330, a pressure applied from the screw 330 to the molding material, and the like.

A pressure detector that detects the pressure of a molding material is not limited to the load detector 360 and a common one may be employed. For example, a nozzle pressure sensor or a cavity pressure sensor may be employed. The nozzle pressure sensor is placed in the nozzle 320.

The injection part 300 executes processes such as a metering process, a filling process, and a dwelling process under the control of the controller 700. The filling process and the dwelling process may be collectively referred to as “injection process.”

In the metering process, the metering motor 340 is driven to rotate the screw 330 at a set rotational speed to feed a molding material forward along the helical groove of the screw 330. With this, the molding material is gradually melted. As the molding material in liquid form is fed forward of the screw 330 to be accumulated in the front portion of the cylinder 310, the screw 330 is moved backward. The rotational speed of the screw 330 is detected using a metering motor encoder 341 or the like. The metering motor encoder 341 detects the rotation of the metering motor 340 and transmits a signal indicating the detection results to the controller 700. A screw rotational speed detector that detects the rotational speed of the screw 330 is not limited to the metering motor encoder 341 and a common one may be employed.

In the metering process, in order to restrict a sudden backward movement of the screw 330, the injection motor 350 may be driven to apply a set back pressure to the screw 330. The back pressure to the screw 330 is detected using the load detector 360, for example. When the screw 330 is moved backward to a metering completion position and a predetermined amount of molding material is accumulated in front of the screw 330, the metering process is completed.

The position and rotational speed of the screw 330 in the metering process are collectively set as a series of set conditions. For example, a metering start position, a rotational speed switch position, and the metering completion position are set. These positions, which are arranged in this order in the backward direction from the front side, represent the start points and end points of sections for which the rotational speed is set. The rotational speed is set section by section. There may be one or more rotational speed switch positions. The rotational speed switch position may not be set. Furthermore, a back pressure is set for each section.

In the filling process, the injection motor 350 is driven to move the screw 330 forward at a set travel speed to fill the cavity space 801 within the mold part 800 with the molding material in liquid form accumulated in front of the screw 330. The position and travel speed of the screw 330 are detected using an injection motor encoder 351, for example. The injection motor encoder 351 detects the rotation of the injection motor 350 and transmits a signal indicating the detection results to the controller 700. When the position of the screw 330 reaches a set position, the filling process switches to the dwelling process (so-called V/P switchover). The position at which V/P switchover occurs may be referred to as “V/P switchover position.” The set travel speed of the screw 330 may be changed according to the position of the screw 330, time, and the like.

The position and travel speed of the screw 330 in the filling process are collectively set as a series of set conditions. For example, a filling start position (also referred to as “injection start position”), a travel speed switch position, and the V/P switchover position are set. These positions, which are arranged in this order in the forward direction from the back side, represent the start points and end points of sections for which the travel speed is set. The travel speed is set section by section. There may be one or more travel speed switch positions. The travel speed switch position may not be set.

The upper limit of the pressure of the screw 330 is set for each section for which the travel speed of the screw 330 is set. The pressure of the screw 330 is detected by the load detector 360. When the pressure of the screw 330 is less than or equal to a set pressure, the screw 330 is moved forward at a set travel speed. When the pressure of the screw 330 exceeds the set pressure, the screw 330 is moved forward at a travel speed lower than the set travel speed so that the pressure of the screw 330 is less than or equal to the set pressure, for mold protection.

In the filling process, after the position of the screw 330 reaches the V/P switchover position, the screw 330 may be temporarily stopped at the V/P switchover position and the V/P switchover may be thereafter performed. Immediately before the V/P switchover, the screw 330 may be moved forward or backward very slowly instead of being stopped. A screw position detector that detects the position of the screw 330 and a screw travel speed detector that detects the travel speed of the screw 330 are not limited to the injection motor encoder 351 and common ones may be employed.

In the dwelling process, the injection motor 350 is driven to push the screw 330 forward to hold the pressure of the molding material at the front end of the screw 330 (hereinafter also referred to as “dwell pressure”) at a set pressure and press the molding material remaining in the cylinder 310 toward the mold part 800. It is possible to compensate for a shortage of molding material due to cooling contracture within the mold part 800. The dwell pressure is detected using the load detector 360, for example. The set value of the dwell pressure may be changed according to elapsed time from the start of the dwelling process or the like. Two or more values may be set for each of the dwell pressure and the dwell time for holding the dwell pressure in the dwelling process, and the dwell pressure and the dwell time may be collectively set as a series of set conditions.

In the dwelling process, the molding material in the cavity space 801 within the mold part 800 is gradually cooled, so that the entrance of the cavity space 801 is filled up with the solidified molding material when the dwelling process is completed. This state, which is referred to as “gate seal,” prevents the backflow of the molding material from the cavity space 801. After the dwelling process, the cooling process is started. In the cooling process, the molding material in the cavity space 801 is solidified. The metering process may be executed during the cooling process in order to reduce molding cycle time.

The injection part 300, which is of an in-line screw type according to the present embodiment, may be of a screw pre-plasticizing type. According to the screw pre-plasticizing injection part, a molding material melted in a plasticizing cylinder is supplied to an injection cylinder, and the molding material is injected into a mold part from the injection cylinder. In the plasticizing cylinder, a screw is so placed as to be rotatable and immovable forward or backward or a screw is so placed as to be rotatable and movable forward and backward. In the injection cylinder, a plunger is so placed as to be movable forward and backward.

Furthermore, the injection part 300, which is of a horizontal type where the axial direction of the cylinder 310 is a horizontal direction according to the present embodiment, may be of a vertical type where the axial direction of the cylinder 310 is a vertical direction. A mold clamping part combined with the injection part 300 of a vertical type may be of a horizontal type or a vertical type. Likewise, a mold clamping part combined with the injection part 300 of a horizontal type may be of a horizontal type or a vertical type.

### (Moving Part)

In the description of the movement part 400, similar to the description of the injection part 300, the direction of movement of the screw 330 during filling (e.g., the negative X-axis direction) is referred to as “forward direction”, and the direction of movement of the screw 330 during metering (e.g., the positive X-axis direction) is referred to as “backward direction.”

The movement part 400 moves the injection part 300 toward and away from the mold part 800. Furthermore, the movement part 400 presses the nozzle 320 against the mold part 800 to generate a nozzle touch pressure. The movement part 400 includes a hydraulic pump 410, a motor 420 serving as a drive source, and a hydraulic cylinder 430 serving as a hydraulic actuator.

The hydraulic pump 410 includes a first port 411 and a second port 412. The hydraulic pump 410, which is a bidirectionally rotatable pump, switches the rotational direction of the motor 420 to take in hydraulic fluid (e.g., oil) from one of the first port 411 or the second port 412 and discharge hydraulic fluid from the other of the first port 411 and the second port 412, thereby generating hydraulic pressure. The hydraulic pump 410 may take in hydraulic fluid from a tank and discharge hydraulic fluid from one of the first port 411 or the second port 412.

The motor 420 causes the hydraulic pump 410 to operate. The motor 420 drives the hydraulic pump 410 with a rotational direction and a rotation torque corresponding to a control signal from the controller 700. The motor 420 may be an electric motor and may be an electric servo motor.

The hydraulic cylinder 430 includes a cylinder body 431, a piston 432, and a piston rod 433. The cylinder body 431 is fixed to the injection part 300. The piston 432 separates the inside of the cylinder body 431 into a front chamber 435 serving as a first chamber and a rear chamber 436 serving as a second chamber. The piston rod 433 is fixed to the stationary platen 110.

The front chamber 435 of the hydraulic cylinder 430 is connected to the first port 411 of the hydraulic pump 410 via a first flow channel 401. Hydraulic fluid discharged from the first port 411 is supplied to the front chamber 435 via the first flow channel 401 to push the injection part 300 forward. The injection part 300 is moved forward to press the nozzle 320 against the stationary mold 810. The front chamber 435 serves as a pressure chamber that generates the nozzle touch pressure of the nozzle 320 with the pressure of the hydraulic fluid supplied from the hydraulic pump 410.

The rear chamber 436 of the hydraulic cylinder 430 is connected to the second port 412 of the hydraulic pump 410 via a second flow channel 402. Hydraulic fluid discharged from the second port 412 is supplied to the rear chamber 436 of the hydraulic cylinder 430 via the second flow channel 402 to push the injection part 300 backward. The injection part 300 is moved backward to separate the nozzle 320 from the stationary mold 810.

According to the present embodiment, the movement part 400 includes the hydraulic cylinder 430. The present disclosure, however, is not limited to this. For example, instead of the hydraulic cylinder 430, an electric motor and a motion conversion mechanism that converts the rotational motion of the electric motor into the linear motion of the injection part 300 may be employed.

### (Controller)

The controller 700, which is composed of, for example, a computer, includes a central processing unit (CPU) 701, a storage medium 702 such as a memory, an input interface (I/F) 703, an output interface (I/F) 704, and a communication interface 705 as illustrated in FIG. 1 and FIG. 2. The controller 700 executes various controls by causing the CPU 701 to execute one or more programs stored in the storage medium 702. Furthermore, the controller 700 receives an external signal at the input interface 703 and transmits a signal to the outside at the output interface 704.

The controller 700 repeatedly produces a molded product by repeatedly executing processes such as the metering process, the mold closing process, the pressurizing process, the mold clamping process, the filling process, the dwelling process, the cooling process, the depressurizing process, the mold opening process, and the ejection process. A series of operations for obtaining a molded product, for example, operations from the start of a metering process and the start of the next metering process, may be referred to as “shot” or “molding cycle.” Furthermore, time required for one shot may be referred to as “molding cycle time” or “cycle time.”

One molding cycle has, for example, the metering process, the mold closing process, the pressurizing process, the mold clamping process, the filling process, the dwelling process, the cooling process, the depressurizing process, the mold opening process, and the ejection process in this order. The order here is order in which the processes are started. The filling process, the dwelling process, and the cooling process are executed during the mold clamping process. The start of the mold clamping process may coincide with the start of the filling process. The completion of the depressurizing process coincides with the start of the mold opening process.

Multiple processes may be simultaneously executed to reduce the molding cycle time. For example, the metering process may be executed during the cooling process of the previous molding cycle or may be executed during the mold clamping process. In such a case, the mold closing process may be executed at the beginning of the molding cycle. Furthermore, the filling process may be started during the mold closing process. Furthermore, the ejection process may be started during the mold opening process. When an on-off valve that opens and closes the flow path of the nozzle 320 is provided, the mold opening process may be started during the metering process. This is because even when the mold opening process is started during the metering process, no molding material leaks from the nozzle 320 as long as the on-off valve closes the flow path of the nozzle 320.

One molding cycle may include one or more processes other than the metering process, the mold closing process, the pressurizing process, the mold clamping process, the filling process, the dwelling process, the cooling process, the depressurizing process, the mold opening process, and the ejection process.

For example, before the start of the metering process after the completion of the dwelling process, a pre-metering suck back process to move the screw 330 backward to a preset metering start position may be executed. This makes it possible to reduce the pressure of the molding material accumulated in front of the screw 330 before the start of the metering process and to prevent a sudden backward movement of the screw 330 at the start of the metering process.

Furthermore, before the start of the filling process after the completion of the metering process, a post-metering suck back process to move the screw 330 backward to a preset filling start position (also referred to as “injection start position”) may be executed. This makes it possible to reduce the pressure of the molding material accumulated in front of the screw 330 before the start of the filling process and to prevent the leakage of the molding material from the nozzle 320 before the start of the filling process.

The controller 700 is connected to an operation device 750 that receives an input operation from a user and a display device 760 that displays a screen. The operation device 750 and the display device 760 may be composed of, for example, a touchscreen 770 as a one-piece structure. The touchscreen 770 serving as the display device 760 displays a screen under the control of the controller 700. For example, information such as the settings of the injection molding machine 10 and the current condition of the injection molding machine 10 may be displayed on the screen of the touchscreen 770. The touchscreen 770 displays a screen area where operations are receivable. For example, operation parts such as buttons and input fields for receiving a user's input operation may be displayed on the screen area of the touchscreen 770. The touchscreen 770 serving as the operation device 750 detects a user's input operation on the screen and outputs a signal according to the input operation to the controller 700. This enables the user to, for example, enter the settings (including setting values) for the injection molding machine 10 by operating the operation parts provided on the screen while checking information displayed on the screen. Furthermore, by operating the operation parts provided on the screen, the user can cause the injection molding machine 10 to perform operations corresponding to the operation parts. The operations of the injection molding machine 10 may be, for example, the operations (including stopping) of the mold clamping part 100, the ejector 200, the injection part 300, the movement part 400, and the like. Furthermore, the operations of the injection molding machine 10 may be, for example, the switching of the screen displayed on the touchscreen 770 serving as the display device 760.

The operation device 750 and the display device 760 of the present embodiment, which are described as being integrated into the touchscreen 770, may be separately provided. Furthermore, two or more operation devices 750 may be provided. The operation device 750 and the display device 760 are disposed on the operation side (the negative side in the Y-axis direction) of the mold clamping part 100 (more specifically, the stationary platen 110).

### (Safety Functions)

As indicated by long dashed double-short dashed lines in FIG. 1 and FIG. 2, the injection molding machine 10 includes a casing 940 covering the mold clamping part 100, the ejector 200, and the mold part 800. The casing 940 has a protective function of preventing a user of the injection molding machine 10 from contacting the mold part 800 or the like during injection molding. The casing 940 may cover the components up to the injection part 300, or may cover the entirety of the injection molding machine 10.

For example, the casing 940 is formed in a rectangular shape (box shape), and fixed to the upper surface of the frame 900 (the mold clamping part frame 910). In the side surface of the casing 940 in the positive X-axis direction, an opening (not shown) through which the cylinder 310 and the nozzle 320 of the injection part 300 can move back and forth is provided.

The casing 940 includes one or more safety doors 941 that can be opened and closed by a user. FIG. 1 and FIG. 2 illustrate an example in which the safety door 941 is placed at the side surface of the casing 940 in the positive Y-axis direction (the front of the paper sheet of the drawing). However, no particular limitation is imposed on where the safety door 941 is placed, and the safety door 941 may be placed at the side surface of the casing 940 in the negative Y-axis direction or the negative X-axis direction, or may be placed at the upper surface of the casing 940 in the positive Z-axis direction. The safety door 941 may be of a one-side opening type, a sliding type, or a both-sides opening type.

The injection molding machine 10 includes an opening/closing detector 942 configured to detect the opening/closing state of the safety door 941. The type of the opening/closing detector 942 according to the present embodiment is, for example, a mechanical switch, which is configured to switch on/off a current output in accordance with the opening/closing state of the safety door 941. The present embodiment does not intend to limit the type of the opening/closing detector 942, and an optical sensor or the like may be used.

The opening/closing detector 942 is communicably connected to the controller 700 and a programmable logic controller (PLC) 710 provided in an inner space 922 on the vertical lower side of the injection part frame 920, and is configured to transmit a signal indicating the opening/closing state of the safety door 941.

The PLC 710 is a computer configured to perform a process in accordance with a procedure defined in a previously stored program, and is an example of the digital circuit for ensuring safety of the injection molding machine 10.

The present embodiment is an example in which the PLC 710 is a safety PLC used to construct a safety control system conforming to the international safety standard (ISO13849 or IEC61508). For example, an IC chip that has received a certification of safety standard is applied as a calculation part 720 of the PLC 710. In the PLC 710 according to the present embodiment, a storage area for handling safety information and a storage area for processing non-safety information are separated. Therefore, even if a malfunction occurs in the storage area for processing non-safety information, it is possible to suppress an impact on the safety information. The present embodiment describes an example in which the safety PLC is used as the PLC 710, but does not intend any limitation to the embodiment in which the safety PLC is used. It is possible to use a general-purpose PLC or a controller to which another processor (e.g., CPU, GPU, ASIC, FPGA, or the like) is applied.

In the PLC 710, an input part 731, an output part 732, and the like, which will be described below, are multiplexed and duplicated. Furthermore, the PLC 710 performs self-diagnosis of the configuration included in the PLC 710 by use of a self-check function, thereby preventing the process of the injection molding machine 10 from continuing when an abnormality occurs in the PLC 710.

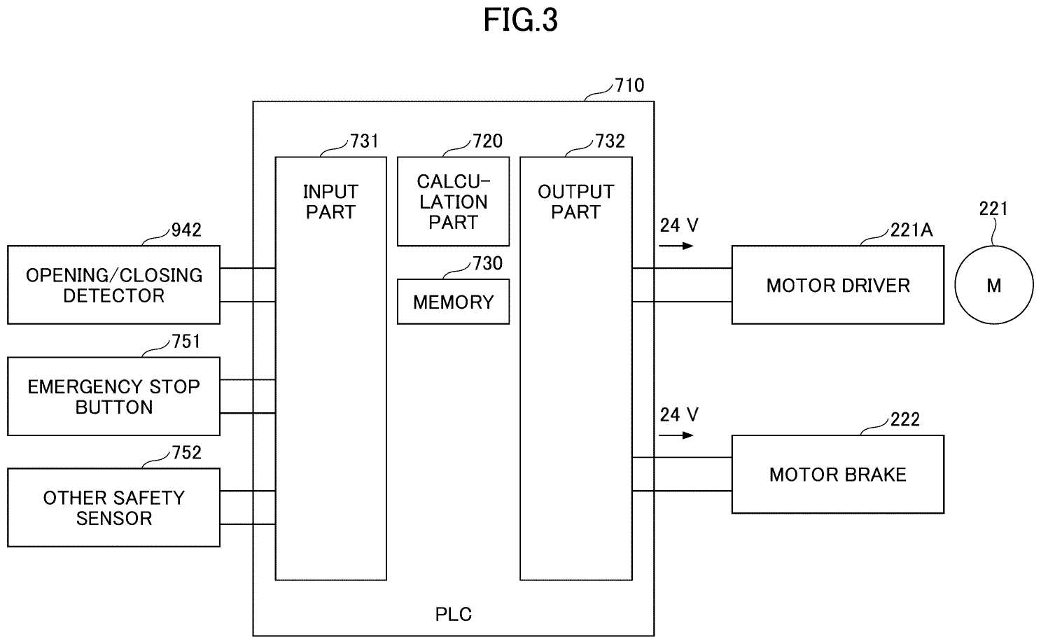

FIG. 3 is a diagram illustrating an example of the electrical configuration of the PLC 710 according to the present embodiment. As illustrated in FIG. 3, the PLC 710 includes the input part 731, the output part 732, the calculation part 720, and a memory 730.

The calculation part 720 is provided to control operations of the PLC 710, and is configured to perform controls for safety of the injection molding machine 10 in accordance with a previously created program. For example, the calculation part 720 controls the movable part to stop when a predetermined event occurs.

The memory 730 is a storage area for storing data (data signals) used by the calculation part 720.

The input part 731 is connected to at least one piece of input equipment selected from various sensors, switches, and buttons provided in the injection molding machine 10, and is configured to receive a signal output from the input equipment.

For example, the input part 731 receives a signal indicating a detection result from the opening/closing detector 942, which detects the opening/closing state of the safety door 941. Also, the input part 731 receives a signal indicating whether or not an emergency stop button 751 is pressed. Furthermore, the input part 731 receives a signal indicating a detection result from another safety sensor 752 provided in the injection molding machine 10.

The output part 732 is connected to a mechanism configured to control the movable part provided in the injection molding machine 10, and is configured to output a signal to this mechanism. The signal output from the output part 732 is, for example, a 24 V voltage signal.

For example, the output part 732 can output the 24 V voltage signal to a motor driver 221A configured to drive the ejector motor 221. The output part 732 according to the present embodiment determines whether or not to output the 24 V voltage signal in accordance with the program executed by the calculation part 720.

The output part 732 can output the 24 V voltage signal to the motor brake 222 configured to stop the ejector motor 221. The output part 732 according to the present embodiment determines whether or not to output the 24 V voltage signal in accordance with the program executed by the calculation part 720.

The PLC 710 illustrated in FIG. 3 illustrates a mechanism configured to control the ejector motor 221, but the control target of the PLC 710 is not limited to the ejector motor 221. As long as the control target of the PLC 710 is a mechanism configured to drive movable parts provided in the injection molding machine 10, the control target of the PLC 710 may be the injection motor 350, the mold thickness adjustment motor 183, and the mold clamping motor 160. Furthermore, the control target of the PLC 710 may be an injection molding machine moving motor (not shown) configured to move the injection molding machine 10 from the frame.

For example, the output part 732 can output the 24 V voltage signal to a motor driver configured to drive the injection motor 350, and the motor brake 352 configured to stop the injection motor 350.

Furthermore, the output part 732 can output the 24 V voltage signal to a motor driver configured to drive the mold thickness adjustment motor 183, and the motor brake 186 configured to stop the mold thickness adjustment motor 183.

Furthermore, the output part 732 can output the 24 V voltage signal to a motor driver configured to drive the mold clamping motor 160, and the motor brake 162 configured to stop the mold clamping motor 160.

Hereinafter, a procedure through which the output part 732 controls the ejector motor 221 will be described. A similar control can be performed for the injection motor 350, the mold thickness adjustment motor 183, the mold clamping motor 160, and the injection molding machine moving motor (not shown), and thus description thereof will be omitted.

For example, in response to receiving a signal indicating detection of opening of the safety door 941 (an example of an occurrence of a predetermined event) from the opening/closing detector 942 (an example of a detector) through the input part 731 while the injection molding machine 10 is in operation, the calculation part 720 controls an output of a signal (24 V voltage signal) (an example of a first signal) to the motor driver 221A so as to perform power interruption for interrupting the power supply to the ejector motor 221, and controls an output of a signal (24 V voltage signal) (an example of a second signal) to the motor brake 222 so as to start braking of the ejector motor 221. The calculation part 720 according to the present embodiment controls the output of the signal for performing power interruption (an example of a first signal) and the output of the signal for starting braking of the ejector motor 221 (an example of a second signal), such that the control of the output of the signal for starting braking of the ejector motor 221 is performed after the control of the output of the signal for performing power interruption. The control of the output of the signal for starting power interruption is, for example, stopping the 24 V voltage signal, and the control of the output of the signal for starting braking is, for example, stopping the 24 V voltage signal. In the present embodiment, the control of the output of the signal is the stop of the voltage signal. However, what the control of the output of the signal is may be determined in accordance with embodiments. For example, the control of the output of the signal may be an output of a stop signal for power interruption, an output of a control signal for driving the motor brake, or the like.

For stopping a movable part (e.g., an ejector rod, a movable mold, or the like) provided in an injection molding machine, power interruption for an actuator configured to operate this movable part and braking control by a brake configured to stop the actuator are typically performed by different controllers. When the power interruption and the braking control are performed by different controllers, the intended order of timing is substantially ensured by constructing an analog delay circuit, such as a relay substrate. However, the delay time varies with components, and thus the delay time can be excessively extended.

In this manner, when stopping the movable part by executing the safety function, there is typically a variation in timing of the braking control to be performed after the power interruption. When the time from the power interruption to the start of the braking by the brake is set to be long, the stop of the movable part is delayed. This may cause a load to the components of the injection molding machine, especially the components of the mold part, or the molded products.

When the time from the power interruption to the start of the braking by the brake is set to be short, there may be a case in which, due to a variation in timing, the power interruption for the actuator configured to operate the movable part and the start of the braking by the brake configured to stop the actuator are reversed with respect to the intended order of timing. In this case, the power interruption is performed after the braking control, and as a result, the braking control by the brake is performed while the actuator is in operation. Thus, wear due to dragging of the brake is caused.

In view of the above, in the present embodiment, the power interruption and the braking control are performed by the PLC 710. That is, by using the single PLC 710, when an event for which the movable part should be stopped (an example of a predetermined event) occurs, the power interruption and the braking control can be controlled such that the braking control is performed after the power interruption. The PLC 710 controls signals so as to ensure the order of the power interruption and the braking by the brake, thereby realizing an improvement in safety.

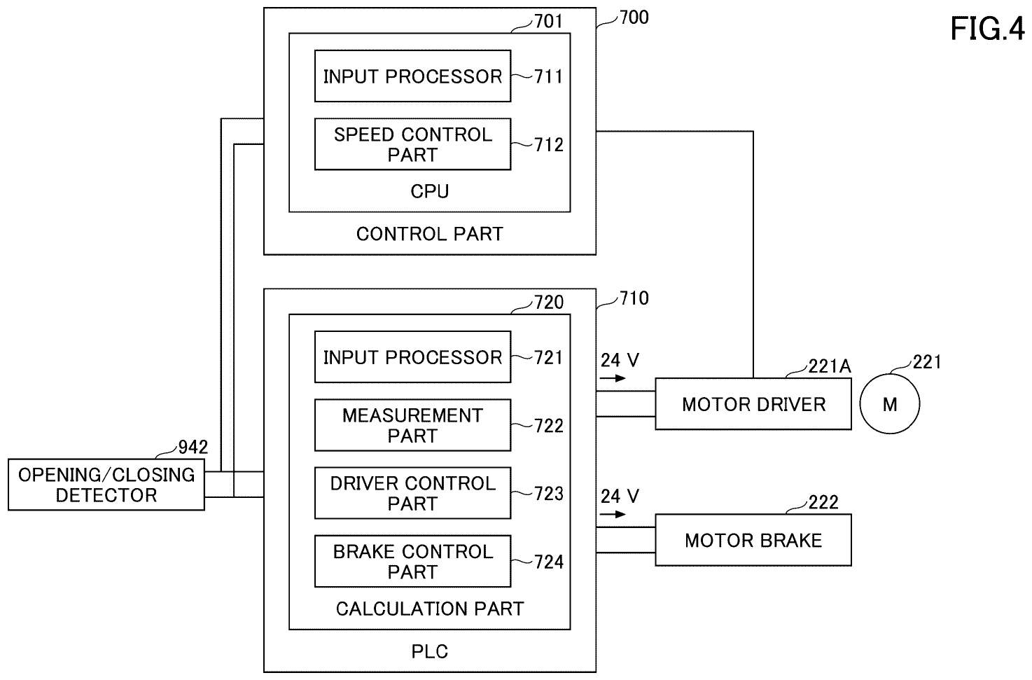

FIG. 4 is a functional configuration diagram illustrating a main configuration of the controller 700 and the PLC 710 according to the present embodiment. FIG. 4 illustrates, as functional blocks, the components of the controller 700 and the PLC 710 of the injection molding machine 10. The functional blocks illustrated in FIG. 3 are conceptual, and do not have to be physically configured as illustrated. All or some of the functional blocks may be functionally or physically distributed or integrated in desired parts. Processing functions executed in the functional blocks in the controller 700 are entirely or partly as desired executed by one or more programs executed in the CPU 701. Alternatively, the functional blocks may be realized as hardware by wired logic.

As illustrated in FIG. 4, the CPU 701 of the controller 700 includes, for example, an input processor 711 and a speed control part 712.

The input processor 711 is configured to receive, from a sensor provided in the injection molding machine 10, an input of a signal indicating a detection result obtained by the sensor. For example, the input processor 711 receives, from the opening/closing detector 942, an input of a signal indicating the opening/closing state of the safety door 941.

The speed control part 712 is configured to control the speed of the actuator by the motor driver based on the signal received by the input processor 711. For example, the speed control part 712 outputs a command to lower the speed of the ejector motor 221 to the motor driver 221A when the safety door 941 is recognized as open in accordance with the signal received by the input processor 711.

Processing functions executed in the functional blocks in the PLC 710 are entirely or partly as desired executed by one or more programs executed in the calculation part 720. Alternatively, the functional blocks may be realized as hardware by wired logic.

As illustrated in FIG. 4, the calculation part 720 of the PLC 710 includes, for example, the input processor 721, a measurement part 722, a driver control part 723, and a brake control part 724.

The input processor 721 is configured to receive, from a sensor provided in the injection molding machine 10, an input of a signal indicating a detection result obtained by the sensor. For example, the input processor 721 receives, from the opening/closing detector 942, an input of a signal indicating the opening/closing state of the safety door 941.

When an occurrence of a predetermined event is detected based on the signal received by the input processor 721, the measurement part 722 measures a time duration from the occurrence of the event. For example, when opening of the safety door 941 is detected, the measurement part 722 measures a time duration from the opening of the safety door 941. The present embodiment does not intend to limit the occurrence of the predetermined event to the case in which the safety door 941 is opened. The occurrence of the predetermined event may be, for example, a case in which pressing of the emergency stop button 751 is detected, or a case in which the another safety sensor 752 detects an abnormal state.

With the detection of the occurrence of the predetermined event serving as a trigger, the driver control part 723 performs control to stop the output of the 24 V voltage signal for performing the power interruption for interrupting the power supply to the actuator provided in the injection molding machine 10 after the waiting time (an example of a second time) has passed based on the measurement result obtained by the measurement part 722. The case in which the waiting time (an example of a second time) has passed since the detection of the occurrence of the predetermined event is, for example, a case in which 100 ms has passed since the opening of the safety door 941.

With the detection of the occurrence of the predetermined event serving as a trigger, the brake control part 724 performs control to stop the output of the 24 V voltage signal to the motor brake for performing the braking control for the actuator provided in the injection molding machine 10 after the total of the waiting time and the delay time based on the measurement result obtained by the measurement part 722. The delay time (an example of a first time) is a time that has passed since the output of the 24 V voltage signal was stopped for performing the power interruption, and is, for example, set to be 50 ms. That is, when 150 ms, i.e., the total of the waiting time and the delay time, has passed since the occurrence of the predetermined event was detected, control is performed to stop the output of the 24 V voltage signal to the motor brake.

The present embodiment has been described based on an example in which the braking control is started after the total of the waiting time and the delay time has passed with the detection of the occurrence of the predetermined event serving as a trigger. However, the present embodiment does not intend to limit the trigger of the start to measure the detection of the occurrence of the predetermined event to the timing at which the occurrence of the predetermined event is detected. For example, it is possible to employ a way to start the braking control after the delay time has passed with execution of the power interruption serving as a trigger.

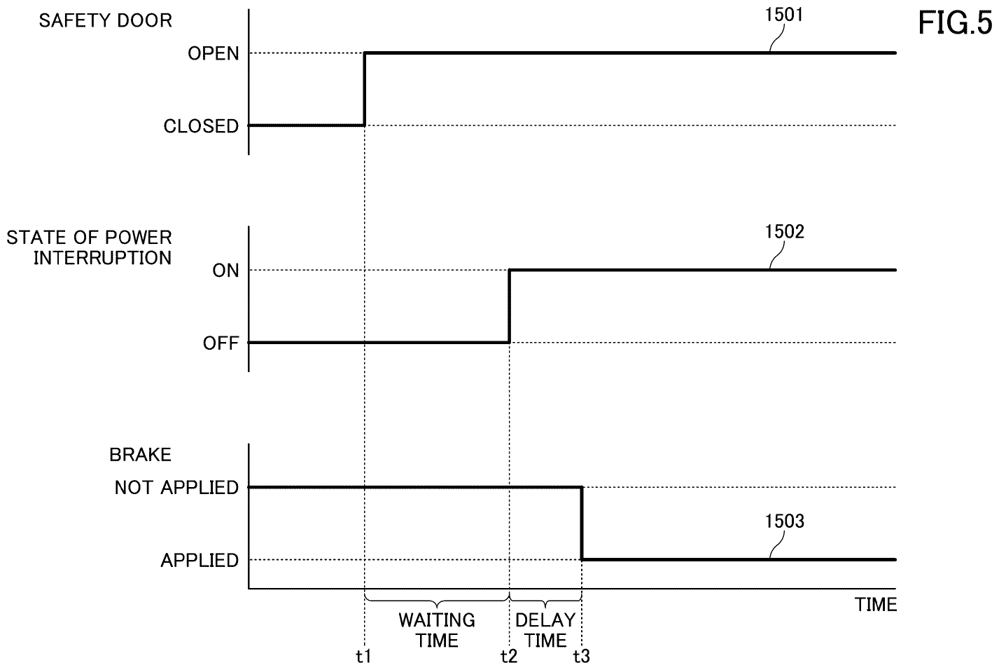

FIG. 5 is a timing chart of the power interruption and the braking control by the motor brake 222 performed when the safety door 941 is opened in the injection molding machine 10 according to the present embodiment.

As indicated by a line 1501 in FIG. 5, the safety door 941 is opened at a point in time of t1. The opening/closing detector 942 outputs, to the controller 700 and the PLC 710, a signal indicating that the safety door 941 is opened. At the timing at which the input processor 711 of the controller 700 receives this signal, the speed control part 712 starts control to lower the speed of the actuator (e.g., the ejector motor 221) for the motor driver (e.g., the motor driver 221A).

In the PLC 710, at the timing at which the input processor 711 receives this signal, the measurement part 722 measures the time duration from the opening of the safety door 941. At a point in time of t2, at which the waiting time (e.g., 100 ms) has passed since the point in time of t1, the driver control part 723 stops the output of the 24 V voltage signal, and performs the power interruption for interrupting the power supply to the actuator (e.g., the ejector motor 221) provided in the injection molding machine 10. Therefore, as indicated by a line 1502, the state of power interruption is on as of the point in time of t2.

Further, in the PLC 710, at a point in time of t3 at which the delay time (e.g., 50 ms) has passed since the point in time of t2, the brake control part 724 stops the output of the 24 V voltage signal, and performs the braking control by the brake provided in the injection molding machine 10 (e.g., the motor brake 222 provided in the ejector motor 221). Therefore, as indicated by a line 1503, the motor brake 222 switches from not being applied to start of braking at the point in time of t3.

The PLC 710 according to the present embodiment previously stores the waiting time and the delay time in a storage part (not shown). When a program is executed in the calculation part 720, the above-described control is performed by referring to the waiting time and the delay time stored in the storage part. Alternatively, the waiting time and the delay time may be set by a user.

In the present embodiment, the power interruption, and the braking by the motor brake 222 are controlled sequentially, i.e., such that the braking is performed after the power interruption, and thus wear of the motor brake 222 can be reduced. In the present embodiment, the delay time between the power interruption and the start of the braking control by the motor brake 222 is set to be as short as possible while sequentially performing the power interruption and the start of the braking control. That is, the present embodiment does not intend to limit the delay time to 50 ms as long as the time between the power interruption and the braking control is set to be as short as possible while sequentially performing the power interruption and the braking control.

Also, in the present embodiment, the controller 700 performs control to lower the speed of the ejector motor 221 at the timing at which the safety door 941 is opened, and the power interruption by the PLC 710 is performed after the waiting time has passed since the detection of the opening. When the power interruption is performed after the speed of the ejector motor 221 has lowered, it is possible to lower the moving speed of the ejector 200 after the power interruption, and reduce a level of wear of the motor brake 222 due to the subsequent braking control.

Also, in the present embodiment, even if the controller 700 does not perform control to lower the speed, the PLC 710 performs the power interruption and the braking control by the brake in accordance with the above-described procedure. That is, even if the controller 700 does not operate as intended, the PLC 710 performs the power interruption and the braking control by the brake, thereby stopping the ejector motor 221. Thus, the PLC 710 according to the present embodiment performs the power interruption and the braking control regardless of whether or not the controller 700 lowers the speed of the ejector motor 221, thereby improving certainty in stopping the ejector motor 221. Therefore, it is possible to realize an improvement in safety.

The present embodiment has been described based on an example in which the control by the controller 700 to lower the speed of the ejector motor 221 is combined with the power interruption by the PLC 710 and the braking control by the brake. However, the present embodiment does not intend any limitation to the manner in which the control by the controller 700 to lower the speed of the ejector motor 221 is combined with the power interruption by the PLC 710 and the braking control by the brake. For example, only the power interruption by the PLC 710 and the braking control by the brake may be performed without performing the control by the controller 700 to lower the speed of the ejector motor 221.

The present embodiment has been described based on an example in which a configuration for performing the power interruption (the motor driver and the actuator) and a configuration for performing the braking control (the motor brake) are separately provided. However, the present embodiment does not intend any limitation to the example in which a configuration for performing the power interruption and a configuration for performing the braking control are separately provided. The configuration for performing the power interruption may be integrated with the configuration for performing the braking control.

### Another Embodiment

The one embodiment refers to the case in which the PLC 710 directly controls the motor brake 222 and the motor driver (e.g., the motor driver 221A). However, the one embodiment does not intend any limitation to the manner in which the PLC 710 directly controls the motor brake 222 and the motor driver (e.g., the motor driver 221A). In view of this, in another embodiment, a case in which control is performed through a relay will be described.

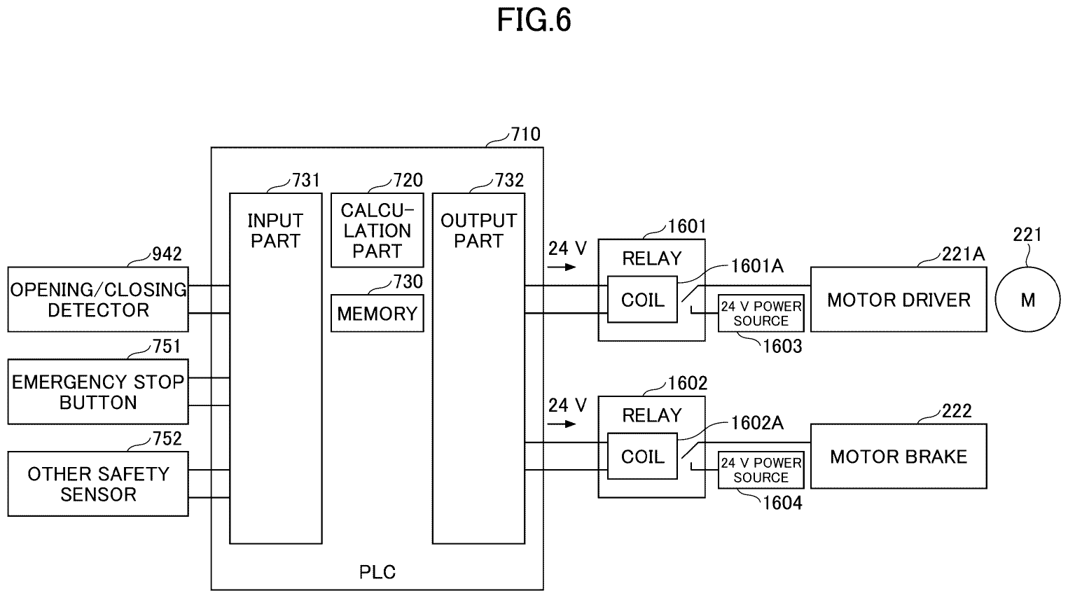

FIG. 6 is a diagram illustrating an example of an electrical configuration of the PLC 710 according to the present embodiment. As illustrated in FIG. 6, the PLC 710 includes the input part 731, the output part 732, the calculation part 720, and the memory 730, as in the one embodiment. In the present embodiment, the same reference symbols are assigned to the same components as in the one embodiment, and description thereof will be omitted.

In the present embodiment, a relay 1601 is provided between: the PLC 710; and the ejector motor 221 and the motor driver 221A. Furthermore, a relay 1602 is provided between the PLC 710 and the motor brake 222.

The motor driver 221A is connected to a 24 V power supply 1603 through the relay 1601. When the PLC 710 outputs the 24 V voltage signal, a current flows through a coil 1601A in the relay 1601, thereby generating a magnetic field. When an iron piece (not shown) contacts a contact by the effect of the magnetic field, a power is supplied from the 24 V power supply 1603 to the motor driver 221A.

Furthermore, the motor brake 222 is connected to a 24 V power supply 1604 through the relay 1602. When the PLC 710 outputs the 24 V voltage signal, a current flows through a coil 1602A in the relay 1602, thereby generating a magnetic field. When an iron piece (not shown) contacts a contact by the effect of the magnetic field, power is supplied from the 24 V power supply 1604 to the motor brake 222.

That is, even if the relays 1601 and 1602 are provided as in the present embodiment, the PLC 710 can control the motor driver 221A and the motor brake 222 by performing the same control as in the one embodiment.

The PLC 710 according to the present embodiment is connected to the motor driver 221A and the motor brake 222 through the relays 1601 and 1602. Therefore, when an overcurrent occurs in the motor driver 221A, the motor brake 222, or the like, the relays 1601 and 1602 can suppress an impact of the overcurrent on the PLC 710. Therefore, it is possible to realize an improvement in safety of the PLC 710.

### Modified Example

In the above-described embodiments, the injection molding machine 10 is a horizontal-type machine. However, these embodiments do not intend any limitation to the case in which the injection molding machine 10 is a horizontal-type machine, and a vertical-type machine may be used. Therefore, a case in which a vertical-type machine is used will be described.

The safety standard (ISO20430 (JIS B6711)) stipulates that injection molding machines should prevent any movement caused by gravity. That is, in a modified example in which a vertical-type machine is used as the injection molding machine 10, when operating a movable part that is movable in the direction of gravity (e.g., mold opening and closing, a movement in mold thickness, or a movement of the injection part), a braking device (e.g., a motor brake) needs to prevent such a movement caused by gravity.

Furthermore, when the power interruption, and the braking control by the brake configured to stop the actuator are performed by different controllers, it is necessary to stop generation of a large amount of energy when a time difference occurs between the power interruption, and the braking control by the brake. Therefore, the power interruption and the braking control are required to be performed at appropriate timings.

In this modified example, the PLC 710 sequentially performs the power interruption for the actuator configured to operate the movable part and the braking control by the motor brake on the movement of the movable part of the injection molding machine of a vertical type at predetermined timings, as in the above-described embodiments. This modified example can perform timing control with higher accuracy than in the case in which an analog delay circuit is used. Thus, it is possible to realize an improvement in safety.

### Effects

By performing the above-described control, the PLC 710 according to the above-described embodiments and modified example can maintain the order of the power interruption for the actuator configured to operate the movable part, and the braking control to stop the actuator. Therefore, it is possible to suppress the power interruption being performed after the braking control, and thus suppress wear of the brake.

Furthermore, it is possible to control the timings at which the PLC 710 performs the power interruption and the braking control. This can suppress a load on the components of the injection molding machine 10 due to a variation in the timing at which the braking control is performed.

In the above-described embodiments and modified example, the calculation part 720 configured as a digital circuit performs the power interruption and the braking control in accordance with a previously created program, and thus it is possible to perform timing control with higher accuracy than in the case in which an analog delay circuit is used.

Furthermore, by employing the safety PLC as the PLC 710 according to the above-described embodiments and modified example, the input part 731, the output part 732, and the like are multiplexed and duplicated, and also the PLC 710 performs self-diagnosis by use of a self-check function, thereby realizing an improvement in safety. Specifically, the input part 731, the output part 732, and the like are multiplexed and duplicated, which can improve certainty in performing stop control of the movable part of the injection molding machine 10 in accordance with a previously created program. Thus, it is possible to realize an improvement in safety.

An aspect of the present disclosure improves certainty in performing power interruption and braking control in this order, thereby realizing an improvement in safety.

Although the embodiments of the PLC (an example of a controller) provided in the injection molding machine, and of the injection molding machine according to the present disclosure have been described above, the present disclosure is not limited to the above-described embodiments and the like. Various changes, modifications, substitutions, additions, deletions, and combinations are possible within the scope of claims recited. These naturally fall within the technical scope of the present disclosure.

What is claimed is:

1. A controller for an injection molding machine, the controller comprising:
a digital circuit configured to, in response to receiving a signal indicating detection of an occurrence of a predetermined event from a detector provided in the injection molding machine including a motor configured to supply power for moving a movable part and including a brake for the motor, control an output of a first signal for performing power interruption for interrupting power supply to the motor and an output of a second signal for starting braking by the brake, such that control of the output of the second signal is performed after control of the output of the first signal.

2. The controller for the injection molding machine according to claim 1, wherein
the digital circuit is configured to, in response to detecting the occurrence of the predetermined event, control the output of the second signal after a first time passes from controlling the output of the first signal.

3. The controller for the injection molding machine according to claim 1, wherein
the digital circuit is configured to, in response to detecting the occurrence of the predetermined event, control the output of the first signal after a second time passes.

4. An injection molding machine, comprising:
a motor configured to supply power for moving a movable part;
a brake for the motor; and
a controller including a digital circuit configured to, in response to receiving a signal indicating detection of an occurrence of a predetermined event, control an output of a first signal for performing power interruption for interrupting power supply to the motor and an output of a second signal for starting braking by the brake, such that control of the output of the second signal is performed after control of the output of the first signal.

5. The injection molding machine according to claim 4, wherein
the motor is an ejector motor configured to drive an ejector provided in the injection molding machine, a mold clamping motor configured to perform mold clamping of a mold part provided in the injection molding machine, an injection motor configured to move a screw forward and backward in a cylinder provided in the injection molding machine, a mold thickness adjustment motor configured to adjust an interval between a stationary platen and a toggle support provided in the injection molding machine, or an injection molding machine moving motor configured to move the injection molding machine from a frame.

6. The injection molding machine according to claim 4, wherein
a relay is provided between the controller and the brake, and
a relay is provided between the controller and the motor.
